(19) United States
(12) Patent Application Publication
(10) Pub. No.: US 2017/0093828 A1
(43) Pub. Date: Mar. 30, 2017

(54) SYSTEM AND METHOD FOR DETECTING WHETHER AUTOMATIC LOGIN TO A WEBSITE HAS SUCCEEDED

(71) Applicants: Nicolas Lupien, Montreal (CA); Michael Lakhia, Montreal (CA); Hubert Gagnon-Lamonde, Montreal (CA)

(72) Inventors: Nicolas Lupien, Montreal (CA); Michael Lakhia, Montreal (CA); Hubert Gagnon-Lamonde, Montreal (CA)

(21) Appl. No.: 14/865,881

(22) Filed: Sep. 25, 2015

(51) Int. Cl. H04L 29/06; H04L 12/26; H04L 29/08

(52) U.S. Cl. CPC H04L 63/08; H04L 67/02; H04L 63/10; H04L 43/0876

(57) ABSTRACT

A technique allows a client computing system with a browser to automatically transmit user credentials to a web account on a web site. The transmitted information may be entered into form fields in a standard browser or a headless browser. The client computing system may also determine whether automatic login of user credentials has succeeded in logging the user to the web account by determining, in some embodiment, “logout” buttons, or other information in web pages that may be received from the web site. Other embodiments include determining whether a landing or redirect web page is received in response to transmitting of the user credentials to the web site.

### TECHNICAL FIELD

Embodiments described herein generally relate to client and server networks and, more particularly, to determining whether automatic login of user credentials into web page for an online account has succeeded.

### BACKGROUND ART

Users typically maintain a number of web-based accounts to personalize a web experience. Examples of such web-based accounts include email accounts, online shopping accounts, online banking accounts, online brokerage accounts, and the like. Most accounts may be accessed in a web browser over a personal computer, mobile device, smart device or other personal device as users may find it convenient to access these accounts on their personal devices when they are away from a desk or home computer. Each web-based account (referred to herein as a web account) requires a user to provide a username, a password, and/or other user credentials in, for example, a web browser so as to provide access to the web account. Each web account may present, in a web page, a web form to the user during initial login and subsequent access to the web account. This web form is a structured document that includes “form fields” for entering user credential information, such as a user ID (a user identifier), a password or the like.

Typically, these different web accounts are created and managed with a username and a simple password. However, security policies of the web service may dictate that user passwords be changed frequently and/or require more complex passwords. Therefore, maintaining different user names and passwords that may be frequently be changed can become difficult and cumbersome for users with their several different web accounts. Further, some e-commerce or online banking web accounts may prompt a user to provide user credentials multiple times, which can be cumbersome and frustrating to the user.

Today, mobile applications are available such as, for example, password manager applications that that provide the ability to store user credentials and later be used for logging a user into the user's online accounts. These mobile applications can also facilitate automatically filling in the user credentials into a web page and logging the user into the account. However, over time, web forms in web pages may be changed and user credentials that are stored on a user device cannot be used. Additionally, these mobile applications that rely on “good” credentials may not able to determine if the user credentials have succeeded in logging the user into the user's web account. A way of automatically logging a user into a web account and determining whether the automatic login has succeeded would be desirable.

### BRIEF DESCRIPTION OF DRAWINGS

FIG. 1 is a diagram illustrating a system for detecting automatic login of user credentials according to one embodiment.

FIG. 2 is a flowchart illustrating a technique for creating context specific user profiles according to one embodiment.

FIG. 3 is a flowchart illustrating a technique for determining successful login into a web account according to one embodiment.

FIG. 4 is a diagram illustrating a computing device for use with techniques described herein according to one embodiment.

FIG. 5 is a block diagram illustrating a computing device for use with techniques described herein according to another embodiment.

FIG. 6 is a diagram illustrating a network of programmable devices according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “computer system” can refer to a single computer or a plurality of computers working together to perform the function described as being performed on or by a computer system.

As used herein, the term “headless browser” can refer to a web browser without a graphical user interface (GUI) that can access web pages over the internet but does not display them in the GUI on a client.

As used herein, the term “web crawler” can refer to an automated program, or script, that methodically scans or “crawls” through Internet pages to create an index of the data it's looking for. There are several uses for the program, perhaps the most popular being search engines using it to provide webs surfers with relevant websites. A web crawler can also be referred to as a web spider, a web robot, a bot, a crawler, and an automatic indexer.

As used herein, the term “web account” refers to a software application that is capable of being accessed over a network and provides access to user information. Examples of web accounts may include an email account, online shopping account, a corporate VPN account, a cloud service based account, an online financial services account including banking, brokerage account, an online social networking account, or the like.

A technique allows a client computing system with a browser to automatically transmit user credentials to a web account on a web site. The transmitted information may be entered into form fields in a standard browser or a headless browser. The client computing system may also determine whether automatic login of user credentials has succeeded in logging the user to the web account by determining, in some embodiment, “logout” buttons, or other information in web pages that may be received from the web site. Other embodiments include determining whether a landing or redirect web page is received in response to transmitting of the user credentials to the web site.

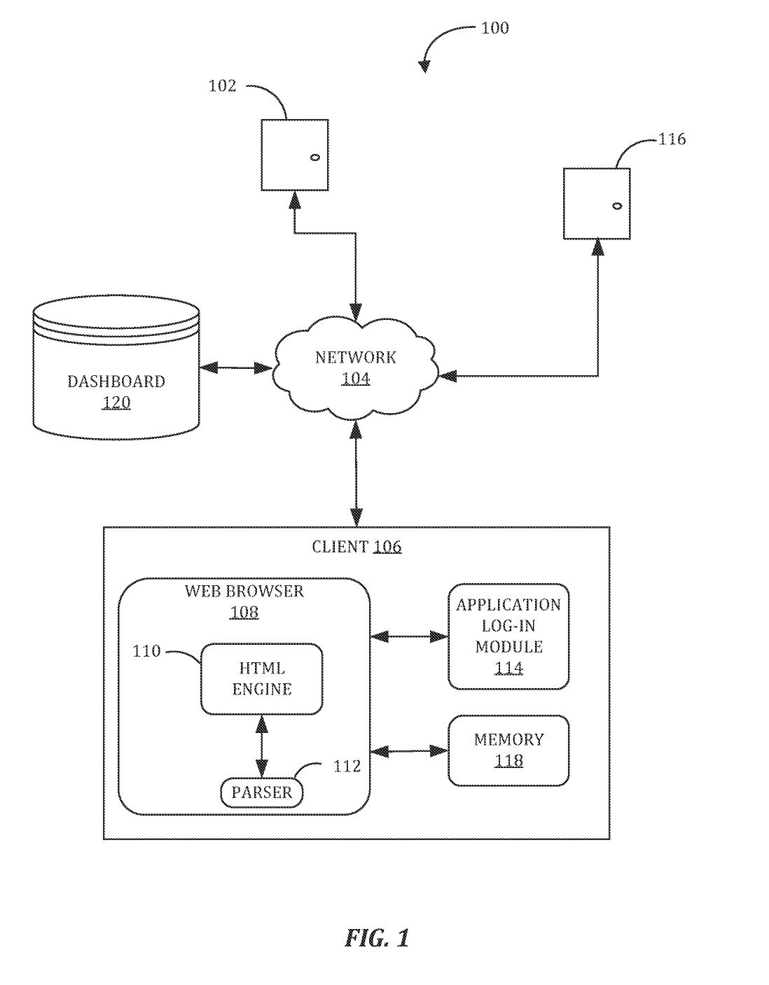

Referring to the figures, FIG. 1 illustrates a system 100 for detecting whether automatic login of user credentials to a web site has succeeded according to one embodiment. System 100 may include a web/content server 102, Internet 104, client machine 106 (or client 106) and third-party server 116. Web server 102 is in communication with client 106 via network 104. Web server 102 is configured to communicate with client 106 for receiving user credentials that may be associated with one or more web accounts on web server 102. The user credentials may be stored in memory 118 and may be used by web server 102 to authenticate a user and/or log the user to a web account on web server 102. In embodiments, web server 102 may be configured to transmit one or more HyperText Markup Language (HTML) web pages to a web browser 108 on client 106 in response to a Hypertext Transfer Protocol (HTTP) request for example, a HTTP GET request from client 106. Web pages that are received from web server 102 can include HTML text, CSS data and form data.

Third-party server 116 may be in communication with client 106 via network 104. Third-party server 116 may include instructions that are executed by one or more processors for processing information from web server 102. In an embodiment, server 116 may be configured to receive information from client 106 for executing, in embodiment, a headless browser for transmitting user credentials to web server 102 and receiving information from web server 102 for determining whether user credentials are successful to log a user into an associated web account on web server 102. Third-party server 116 may be configured to identify login fields in web forms such as, for example, fields associated with login and logout buttons, password fields, or the like so as to determine if log-in into web server 102 was successful.

Client 106 may include a desktop computer, a laptop computer, a smart phone, a tablet device or any other type of electronic device having a processor and networking capabilities. Client 106 may include a web browser 108 and an application log-in module 114. In embodiments, web browser 108 may be a traditional web browser that is configured to communicate information in web pages to a user via a GUI or may be a headless browser that executes one or more processes in the background to transmit and receive information from web server 102. Web browser 108 may include a HTML execution engine 110 and a parser 112. HTML execution engine 110 interprets and executes the rewritten web pages that are received via network 104. Parser 112 may be in communication with HTML execution engine 110 and may be configured to translate the rewritten web pages from web server 102 into a tree structure of Document Object Model (DOM) element and attribute nodes.

Client 106 may also include an application log-in module 114. Application log-in module 114 (or application module 114) may store user credentials for one or more web accounts of a user. Application log-in module includes instructions that may be executed by a processor on client 106 to facilitate automatically logging a user into a web account on web server 102 and to determine whether login was successful, as described herein. In an embodiment, application module 114 may be configured to communicate user credentials to web server 102 for logging-in a user to one or more user associated web accounts and may be configured to determine whether login-of the user is successful by, in some embodiment, evaluating latency time after communicating user credentials and/or determining whether web pages that are received from web server 102 includes information or data that indicates that log was successful. In an embodiment, application module 114 may communicate information to third-party server 116 for determining whether login was successful. Application module 114 may also be configured to store and/or transmit information to a dashboard 120 via network 104 that measures server 116 that measures how often automatic login to server was successful, as login statistics information. Login statistics information may also be received by client 106 and or server 116 for presenting login information via a display. Network 104 is not limited to a network of interconnected computer networks that use an internet protocol (IP), and can also include the Internet and other high-speed data networks and/or telecommunications networks that are configured to pass information back and forth to client 106 via Network 104. Also, while two servers 102 and 116 are depicted in the example of system 100, any number of servers are contemplated to be in communication with client 106 for implementing embodiments of the invention described herein.

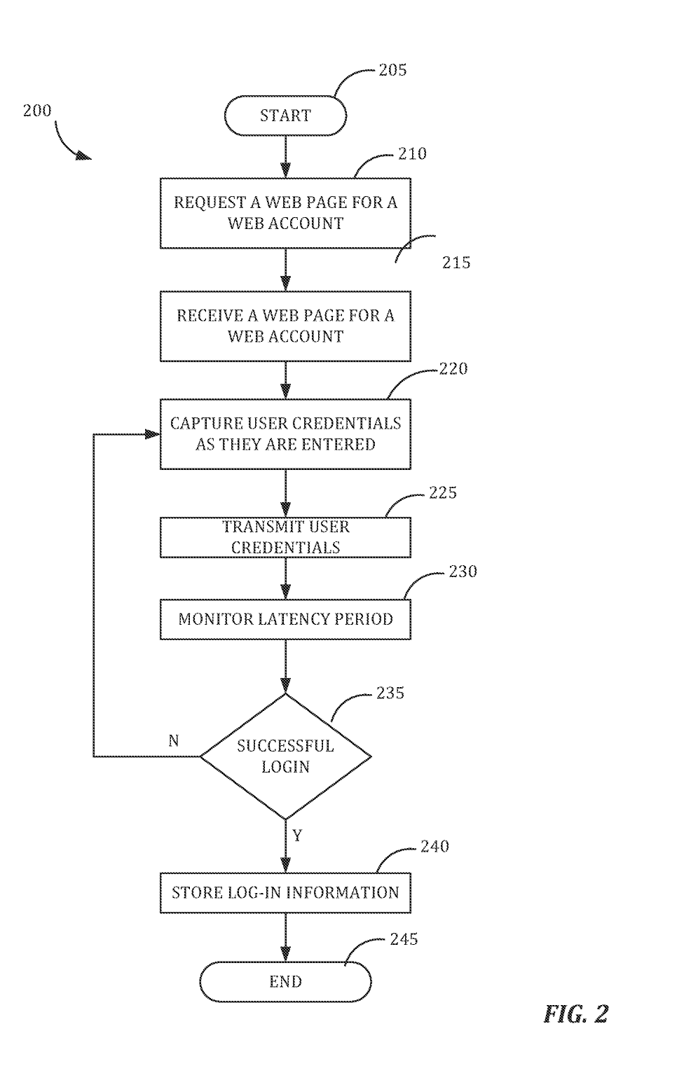

FIG. 2 is a flowchart illustrating a process 200 that may be performed by system 100 of FIG. 1 for capturing one or more user credentials for a web account according to an embodiment of the invention. The user credentials may be captured by log-in module 114 that monitors activity on client 106 during initial web account creation or during initial log-in into a web account using client 106, according to an embodiment.

With continued reference to FIG. 1, process 200 begins in step 205. In 210, a user of client 106 may request a web page from web server 102 by using, for example, web browser 108. The web page that is requested may facilitate creation of a web account on web server 102 or for accessing an existing web account associated with the user. Also, activity performed by the user on web browser may be tracked by application log-in module 116 that may run as a background process on client 106.

In 215, web browser 108 may receive an HTML web page for a web domain from web server 102 in response to an HTTP request from web browser 108. The web page may include a credential entry section as a web form having “form fields” for entering user credential information such as, for example, a user ID (a user identifier), a password, and clickable “submit” buttons and additionally listening for an Enter or Return button “Keypress”. In an embodiment, application module 114 may parse the web page for identifying a clickable “submit” button and register or store the location of the clickable “submit” button for a specific URL or web domain in memory 118. Registering “submit” buttons may provide information on user clicks and/or other user activity on client 106 when monitoring user behavior during credential capture so as to ascertain that the user clicked on the correct buttons during logging into a web site.

In 220, user credentials that are entered by a user, in embodiments, can be captured as they are entered, after entering “Submit” button on Keypress but prior to transmission to web server 102, or after submitting the web form but prior to navigation to a new page as determined by a network request. In 225, user credentials may be transmitted to web server 102 via Network 104. In an embodiment, credential information may be entered into form fields in web browser 108 and data is transmitted to a web server 102, for example, in response to an HTTP request. Credential information that is transmitted may be used by web server 102 for creating a web account associated with a web site on web server 102 or may be used for accessing data or information from an existing web account for a user on web server 102. During credential entry, application module 114 may monitor, in the background, user credentials that are entered into form fields in web browser 108. For example, application module 114 may monitor credential entry section by monitoring user activity on client 106. For example, application module 114 may monitor “key clicks” in a virtual keyboard that may be used to determine credential information in a textual format, monitor audio for voice inputs or monitor key clicks from a physical keyboard during textual entry.

In 225, user credentials that are transmitted may be captured and stored in memory. In 230, web latency may be measured after transmission of credentials. For example, latency may be measured for a time period from the time user credentials are transmitted to a web site at a web server 102 to the time when a refreshed web page is received from web server 102. In 235, the refreshed web page is analyzed for attributes to determine whether login to a web site at web server 102 was successful by monitoring network 104 for a landing web page or a redirect webpage. For example, if “logout” buttons or other attributes are found in web pages such as, for example, a “landing webpage” with “logout” buttons that indicates successful log-in or if a “redirect” webpage is received that does not include “logout” buttons, which indicates unsuccessful log-in. In one embodiment, a redirect web page may also contain an error message that includes a web form for reentering user credentials (i.e., Step 235=“N”), then step 235 proceeds back to step 220, where a user may reenter user credentials via the redirect web page. Latency period for unsuccessful login may also be stored in memory. User credentials that were captured are deleted from memory for unsuccessful login. However, if login is successful where browser receives a landing page as a successive webpage (i.e., Step 235=“Y”), then step 235 proceeds to step 240 where, in an embodiment, login credentials for successful log-in are stored by application module 114 in memory 118 on client 106, and unsuccessful login credentials are deleted from memory. In another embodiment, web latency time period may also be stored by application module 114 in memory 118. Application module 114 may also associate user credentials with a specific web account and store the same in memory 118. The process ends in 245.

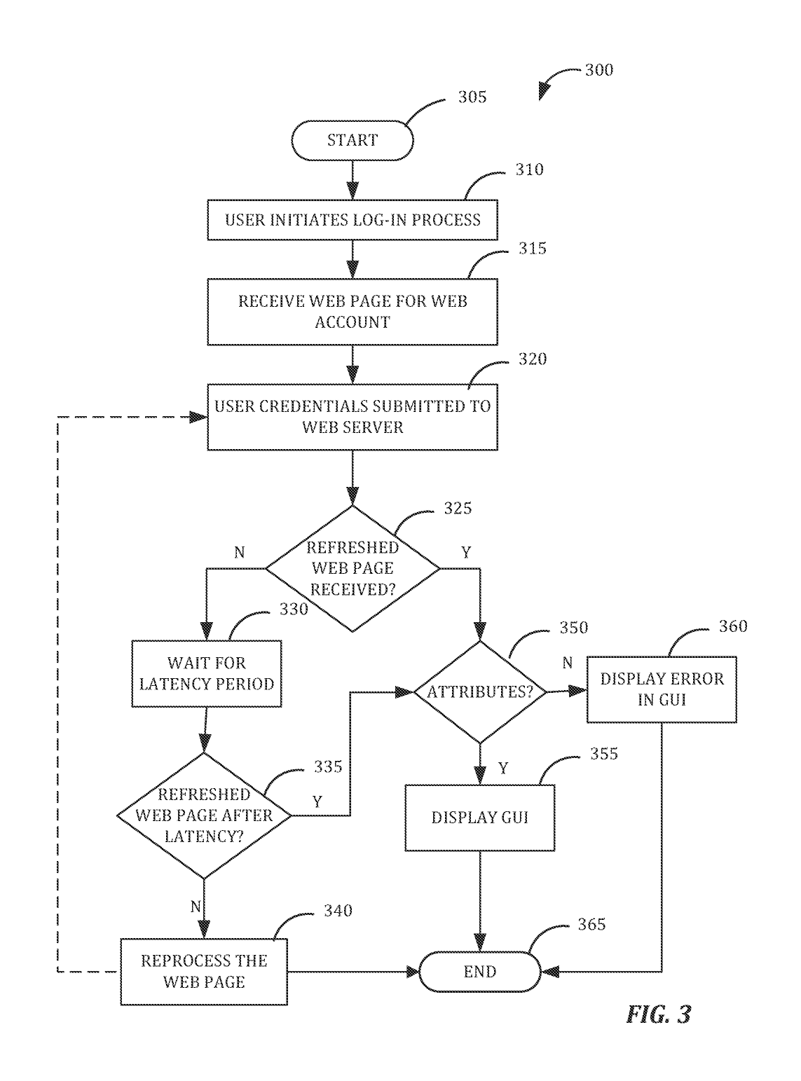

FIG. 3 is a flowchart illustrating a technique or process 300 for detecting whether user log-in credentials are successful to log a user into a website according to an embodiment. With continued reference to FIG. 1, process 300 begins in step 305. In 310, a client 106 may initiate a log-in process into a web account on web server 102 by requesting a web page such as, for example, requesting a web page for a web site through an HTTP GET request via client 106. In an embodiment, a user of client 106 may initiate log-in into the user's web account by requesting a web page associated with a web account via a web browser 108. In another embodiment, a user may execute application module 114 and select web account information stored on application module 114. For example, a user of client 106 may use application log-in module 114 to select on a graphical user interface (GUI) a web account that the user wants to log-into, whereby application module 114 may subsequently request a web page for the specific web account.

In 315, client 108 may receive a web page from web server 102 in response to initiating a log-in process. In an example, the received web page may be displayed in a web browser 108 or, alternatively, may be received in a headless browser on server 116. Also, the web page may include credential entry fields in a web form that may be used for transmitting user credentials to a web account for a web site at server 102.

In 320, user credentials may be transmitted to web server 102. For example, application module 114 may obtain user credentials from memory and e insert the user credentials into credential entry fields in a web form, which are transmitted to web server 102 for logging client 106 into the web account. In some examples, application module 114 may transmit user credentials via web browser 108 on client 106 or may transmit user credentials to server 116, which communicates user credentials to web server 102 via a headless browser.

In 325, application module 114 may receive information regarding a refreshed web page in response to transmitting user credentials to web server 102. In embodiments, application module 114 may receive information from headless browser on server 116 that may process information received from web server 102 so as to determine whether a refreshed web page is received from web server 102 or, alternatively, application module 114 may receive information from web server 102 so as to determine whether a refreshed web page is received. In one example, a refreshed web page may not be received because a page load may not have completed after transmitting user credentials or a refreshed web page is not available from web server 102. If a refreshed web page has not been received (i.e., step 325=“N”), then, in step 330, client 106 or server 116 may wait for a predetermined or calculated latency period for a refreshed web page. The latency period may be received from memory 118 or may be calculated. In 335, after expiration of the latency period and in step 335, when a refreshed page is not received (i.e., step 335=“N”), then, in step 340, web page may be reprocessed. For example, the web page may be inspected to determine if one or more variables are present such as, for example, “log-out” buttons, textual information referencing errors in user authentication, or other credential entry fields. In other embodiments, reprocessing may include transmitting information for unsuccessful log-in to dashboard 120 and displaying a redirected web page on a GUI in web browser 108 for retransmitting user credentials to web server 102 for logging the user into the web account. Information captured during reprocessing may be transmitted to dashboard 120.

However, if a refreshed web page is received (i.e., step 325=“Y” or step 335=“Y”), then in step 350, the web page may be inspected/analyzed to determine whether the web page include one or more attributes. Presence of one or more attributes in the web page may indicate a successful log-in or an unsuccessful log-in. In some non-limiting examples, the web page may be inspected via a headless browser at server 116 or by application module at client 106 to determine if attributes such as, for example, a “logout” button, one or more credential entry fields such as a “username” or a “user id” entry field, or attributes in textual information is available on the refreshed web page that may indicate that log-in was successful (such as for example, a landing page which includes a “logout” button) or unsuccessful such as, for example, a redirect page with textual information or presence of “username” credential entry field without a logout button). Information that is determined during inspection/analysis of the web page may be sent to dashboard 120 to capture log-in statistics associated with logging-in the user into one or more web accounts. In 350, if attributes are present indicating a successful log-in (i.e., step 350=“Y”), then, in 355, application module 114 may send information to dashboard 120 and display a GUI (or also called a “banner”) for the user's web account 108 that notifies the user of a successful log-in. However, in 350, if attributes are present indicating an unsuccessful log-in (i.e., step 350=“N”), then in step 360, application module 114 may send information to dashboard 120 and display an error redirect web page 108. Process ends in step 365

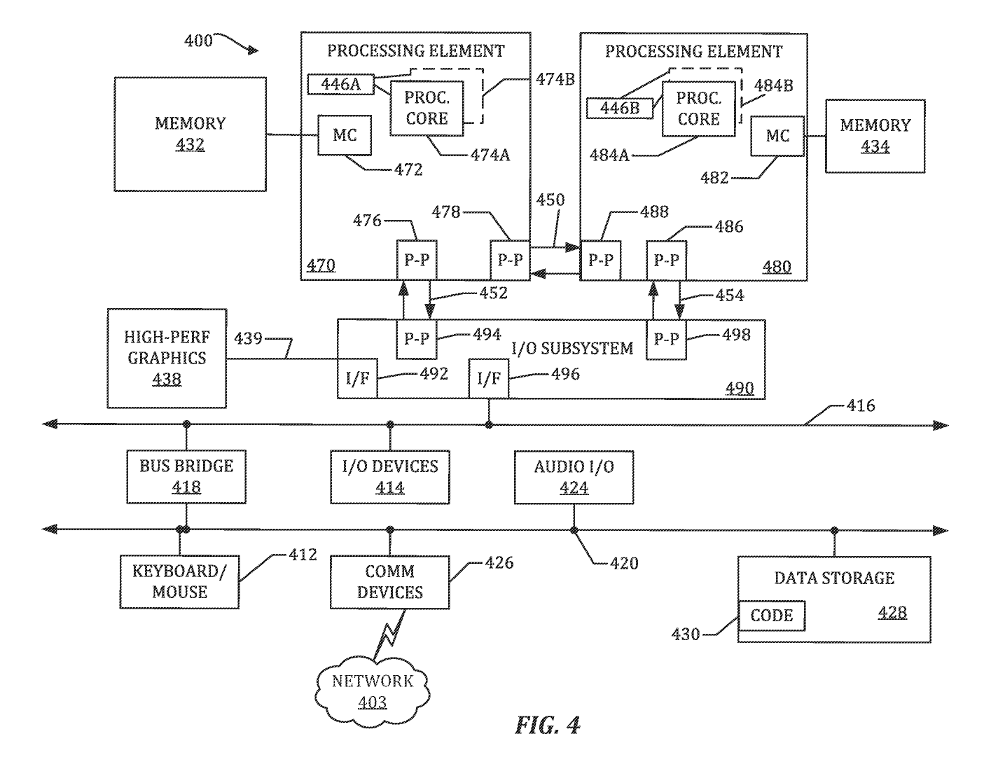

Referring now to FIG. 4, a block diagram illustrates a programmable device 400 that may be used within web server 102, server 116 or client 106 in accordance with one embodiment. The programmable device 400 illustrated in FIG. 4 is a multiprocessor programmable device that includes a first processing element 470 and a second processing element 480. While two processing elements 470 and 480 are shown, an embodiment of programmable device 400 may also include only one such processing element.

Programmable device 400 is illustrated as a point-to-point interconnect system, in which the first processing element 470 and second processing element 480 are coupled via a point-to-point interconnect 450. Any or all of the interconnects illustrated in FIG. 4 may be implemented as a multi-drop bus rather than point-to-point interconnects.

As illustrated in FIG. 4, each of processing elements 470 and 480 may be multicore processors, including first and second processor cores (i.e., processor cores 474a and 474b and processor cores 484a and 484b). Such cores 474a, 474b, 484a, 484b may be configured to execute instruction code in a manner similar to that discussed above in connection with FIGS. 1-3. However, other embodiments may use processing elements that are single core processors as desired. In embodiments with multiple processing elements 470, 480, each processing element may be implemented with different numbers of cores as desired.

Each processing element 470, 480 may include at least one shared cache 446. The shared cache 446a, 446b may store data (e.g., instructions) that are utilized by one or more components of the processing element, such as the cores 474a, 474b and 484a, 484b, respectively. For example, the shared cache may locally cache data stored in a memory 432, 434 for faster access by components of the processing elements 570, 580. In one or more embodiments, the shared cache 446a, 446b may include one or more mid-level caches, such as level 2 (L2), level 3 (L3), level 4 (L4), or other levels of cache, a last level cache (LLC), or combinations thereof.

While FIG. 4 illustrates a programmable device with two processing elements 470, 480 for clarity of the drawing, the scope of the present invention is not so limited and any number of processing elements may be present. Alternatively, one or more of processing elements 470, 480 may be an element other than a processor, such as an graphics processing unit (GPU), a digital signal processing (DSP) unit, a field programmable gate array, or any other programmable processing element. Processing element 480 may be heterogeneous or asymmetric to processing element 470. There may be a variety of differences between processing elements 470, 480 in terms of a spectrum of metrics of merit including architectural, microarchitectural, thermal, power consumption characteristics and the like. These differences may effectively manifest themselves as asymmetry and heterogeneity amongst processing elements 470, 480. In some embodiments, the various processing elements 470, 480 may reside in the same die package.

First processing element 470 may further include memory controller logic (MC) 472 and point-to-point (P-P) interconnects 476 and 478. Similarly, second processing element 480 may include a MC 482 and P-P interconnects 486 and 488. As illustrated in FIG. 4, MCs 472 and 482 couple processing elements 470, 480 to respective memories, namely a memory 432 and a memory 434, which may be portions of main memory locally attached to the respective processors. While MC logic 472 and 482 is illustrated as integrated into processing elements 470, 480, in some embodiments the memory controller logic may be discrete logic outside processing elements 470, 480 rather than integrated therein.

Processing element 470 and processing element 480 may be coupled to an I/O subsystem 490 via respective P-P interconnects 476 and 486 through links 452 and 454. As illustrated in FIG. 4, I/O subsystem 490 includes P-P interconnects 494 and 498. Furthermore, I/O subsystem 490 includes an interface 492 to couple I/O subsystem 490 with a high performance graphics engine 438. In one embodiment, a bus (not shown) may be used to couple graphics engine 438 to I/O subsystem 490. Alternately, a point-to-point interconnect 439 may couple these components.

In turn, I/O subsystem 490 may be coupled to a first link 416 via an interface 496. In one embodiment, first link 416 may be a Peripheral Component Interconnect (PCI) bus, or a bus such as a PCI Express bus or another I/O interconnect bus, although the scope of the present invention is not so limited.

As illustrated in FIG. 4, various I/O devices 414, 424 may be coupled to first link 416, along with a bridge 418 which may couple first link 416 to a second link 420. In one embodiment, second link 420 may be a low pin count (LPC) bus. Various devices may be coupled to second link 420 including, for example, a keyboard/mouse 412, communication device(s) 426 (which may in turn be in communication with the computer network 403), and a data storage unit 428 such as a disk drive or other mass storage device which may include code 430, in one embodiment. The code 430 may include instructions for performing embodiments of one or more of the techniques described above. Further, an audio I/O 424 may be coupled to second link 420.

Note that other embodiments are contemplated. For example, instead of the point-to-point architecture of FIG. 4, a system may implement a multi-drop bus or another such communication topology. Although links 416 and 420 are illustrated as busses in FIG. 4, any desired type of link may be used. Also, the elements of FIG. 4 may alternatively be partitioned using more or fewer integrated chips than illustrated in FIG. 4.

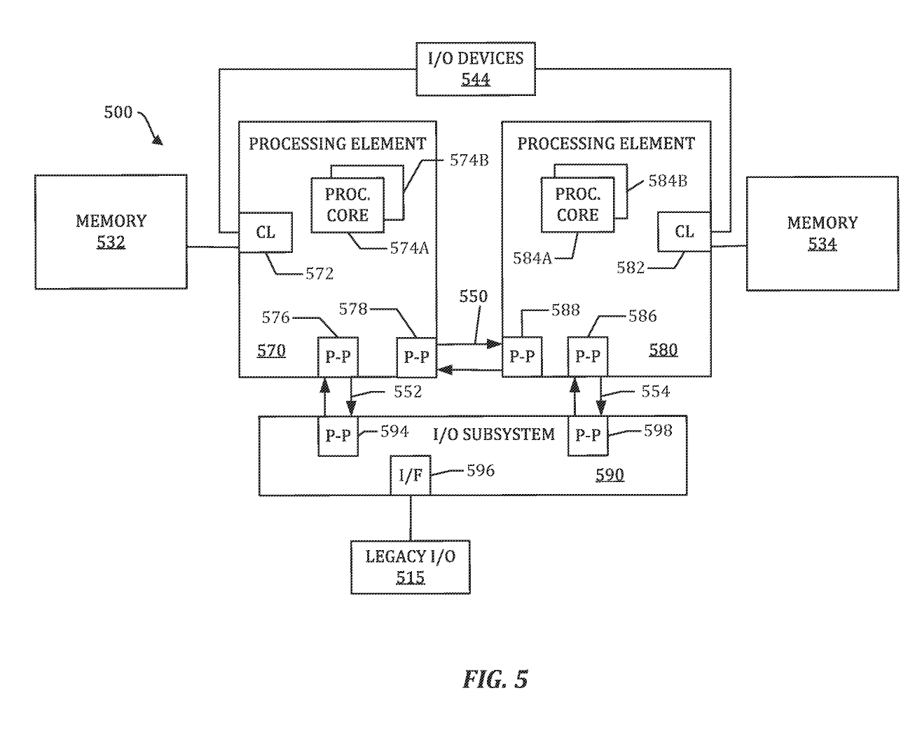

Referring now to FIG. 5, a block diagram illustrates a programmable device 500 according to another embodiment. Certain aspects of FIG. 5 have been omitted from FIG. 5 in order to avoid obscuring other aspects of FIG. 5.

FIG. 5 illustrates that processing elements 570, 580 may include integrated memory and I/O control logic (“CL”) 572 and 582, respectively. In some embodiments, the 572, 582 may include memory control logic (MC) such as that described above in connection with FIG. 5. In addition, CL 572, 582 may also include I/O control logic. FIG. 5 illustrates that not only may the memories 532, 534 be coupled to the 572, 582, but also that I/O devices 544 may also be coupled to the control logic 572, 582. Legacy I/O devices 515 may be coupled to the I/O subsystem 590 by interface 596. Each processing element 570, 580 may include multiple processor cores, illustrated in FIG. 5 as processor cores 574A, 574B, 584A and 584B. As illustrated in FIG. 5, I/O subsystem 590 includes point-to-point (P-P) interconnects 594 and 598 that connect to P-P interconnects 576 and 586 of the processing elements 570 and 580 with links 552 and 554. Processing elements 570 and 580 may also be interconnected by link 550 and interconnects 578 and 588, respectively.

The programmable devices depicted in FIGS. 4 and 5 are schematic illustrations of embodiments of programmable devices which may be utilized to implement various embodiments discussed herein. Various components of the programmable devices depicted in FIGS. 4 and 5 may be combined in a system-on-a-chip (SoC) architecture.

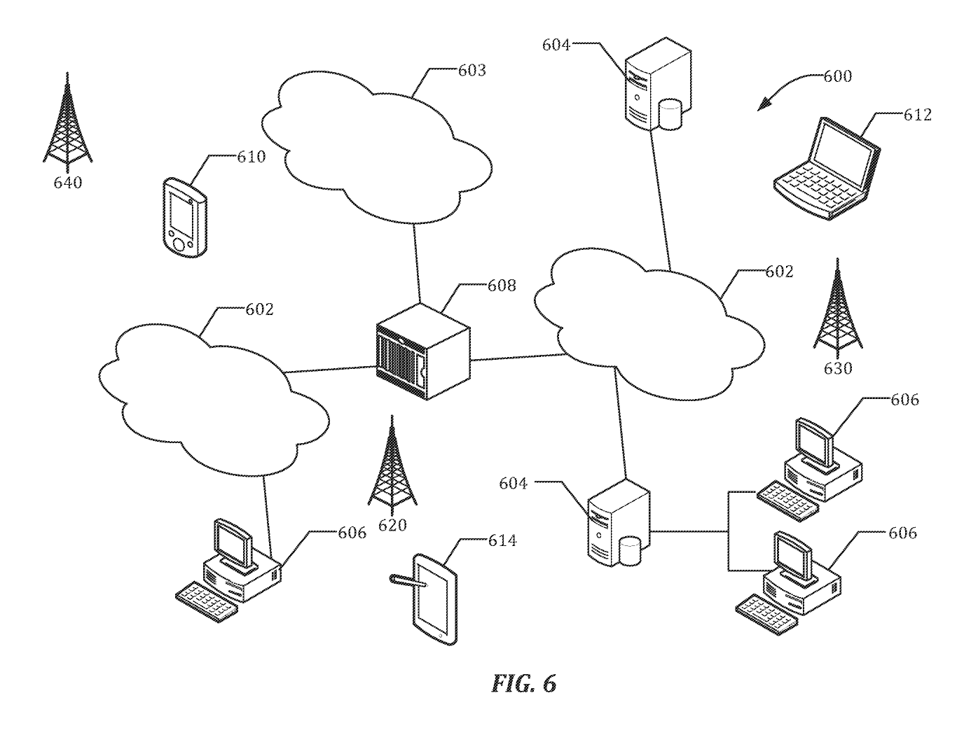

Referring now to FIG. 6, an example infrastructure 600 in which the techniques described above may be implemented is illustrated schematically. Infrastructure 600 contains computer networks 602. Computer networks 602 may include many different types of computer networks available today, such as the Internet, a corporate network or a Local Area Network (LAN). Each of these networks can contain wired or wireless programmable devices and operate using any number of network protocols (e.g., TCP/IP). Networks 602 may be connected to gateways and routers (represented by 608), end user computers 606, and computer servers 604. Infrastructure 600 also includes cellular network 603 for use with mobile communication devices. Mobile cellular networks support mobile phones and many other types of mobile devices. Mobile devices in the infrastructure 600 are illustrated as mobile phones 610, laptops 612 and tablets 614. A mobile device such as mobile phone 610 may interact with one or more mobile provider networks as the mobile device moves, typically interacting with a plurality of mobile network towers 620, 630, and 640 for connecting to the cellular network 603. Although referred to as a cellular network in FIG. 6, a mobile device may interact with towers of more than one provider network, as well as with multiple non-cellular devices such as wireless access points and routers 608. In addition, the mobile devices 610, 612 and 614 may interact with non-mobile devices such as computers 604 and 606 for desired services, which may include providing the application, script, or web content in web pages to a web browser at a client described above. The functionality of the server 116 or client 106 may be implemented in any device or combination of devices illustrated in FIG. 6; however, most commonly is implemented in a network system.

The following examples pertain to further embodiments.

Example 1 is a machine readable medium, on which are stored instructions, comprising instructions that when executed cause a machine to: capture user credentials for a web account; transmit the user credentials for the web account to a web server, wherein the web account is associated with a web site; determine whether a refreshed web page is received from the web server responsive to transmitting the user credentials ; determine whether the refreshed web page includes one or more attributes indicative of a successful log-in into the web site responsive to receiving the refreshed web page; and display information related to a second web page responsive to determining whether the refreshed web page includes the one or more attributes.

In Example 2, the subject matter of Example 1 can optionally include wherein the instructions further comprise instructions that when executed cause the machine to transmit log-in information to a dashboard responsive to determining whether the refreshed web page includes the one or more attributes.

In Example 3, the subject matter of Example 1 to 2 can optionally include, wherein the instructions further comprise instructions that when executed cause the machine to: wait for a predetermined latency period responsive to determining that the refreshed web page is not received from the web server.

In Example 4, the subject matter of Example 3 can optionally include, wherein the instructions further comprise instructions that when executed cause the machine to reprocess the web page responsive to waiting the predetermined latency period.

In Example 5, the subject matter of Example 1 to 4 can optionally include, wherein the instructions to transmit user credentials further comprise instructions that when executed cause the machine to automatically retrieve and transmit a user identification and a user password from memory to the web server.

In Example 6, the subject matter of Example 1 to 5 can optionally include, wherein the instructions further comprise instructions that when executed cause the machine to receive information related to determining whether the refreshed web page include the one or more attributes from a remote third-party server.

In Example 7, the subject matter of Example 1 to 6 can optionally include, wherein the instructions to determine whether the refreshed web page includes the one or more attributes further comprise instructions that when executed cause the machine to display user content associated with the web account in a display responsive to determining that the refreshed web page includes the one or more attributes.

In Example 8, the subject matter of Example 1 to 7 can optionally include, wherein the instructions to determine whether the refreshed web page includes the one or more attributes further comprise instructions that when executed cause the machine to not display user content associated with the web account in a display responsive to determining that the refreshed web page does not include the one or more attributes.

Example 9 is a computer system for determining successful access to a web site, comprising: one or more processors; and a memory coupled to the one or more processors, on which are stored instructions, comprising instructions that when executed cause one or more of the processors to: transmit user credentials for a web account to a web server, wherein the web account is associated with the web site; determine whether a refreshed web page is received from the web server responsive to transmitting the user credentials; determine whether the refreshed web page includes one or more attributes indicative of a successful log-in into the web site responsive to receiving the refreshed web page; and display information related to a second web page responsive to determining whether the refreshed web page includes the one or more attributes.

In Example 10, the subject matter of Example 19 can optionally include, wherein the instructions further comprise instructions that when executed cause the one or more processors to transmit information related to the successful log-in to a dashboard responsive to determining whether the refreshed web page includes the one or more attributes.

In Example 11, the subject matter of Example 9 to 10 can optionally include, wherein the instructions further comprise instructions that when executed cause the one or more processors to wait for a predetermined latency period responsive to determining that the refreshed web page is not received from the web server.

In Example 12, the subject matter of Example 11 can optionally include, wherein the instructions further comprise instructions that when executed cause the one or more processors to reprocess the web page responsive to waiting the predetermined latency period.

In Example 13, the subject matter of Example 9 to 12 can optionally include, wherein the instructions further comprise instructions that when executed cause the one or more processors to automatically retrieve and transmit a user identification and a user password from memory to the web server.

In Example 14, the subject matter of Example 9 to 13 can optionally include, wherein the instructions further comprise instructions that when executed cause the one or more processors to receive information related to determining whether the refreshed web page include the one or more attributes from a remote third-party server.

In Example 15, the subject matter of Example 9 to 14 can optionally include, wherein the instructions further comprise instructions that when executed cause the one or more processors to display user content associated with the web account in a display responsive to determining that the refreshed web page includes the one or more attributes.

In Example 16, the subject matter of Example 9 to 15 can optionally include, wherein the instructions further comprise instructions that when executed cause the one or more processors to not display user content associated with the web account in a display responsive to determining that the refreshed web page does not include the one or more attributes.

Example 17 is a computer system for storing user information, comprising: one or more processors; and a memory coupled to the one or more processors, on which are stored instructions, comprising instructions that when executed cause one or more of the processors to: transmit a request for a web page; receive a second web page responsive to transmitting the request, wherein the second web page includes information related to a web account of a user; transmit user credentials within the second web page; capture user credentials as they are being transmitted; analyze a refreshed web page responsive to transmitting the user credentials; and determine whether the user credentials are successful to log-in into the web account.

In Example 18, the subject matter of Example 17 can optionally include, wherein the instructions further comprise instructions that when executed cause the one or more processors to monitor latency period responsive to transmitting the user credentials.

In Example 19, the subject matter of Example 17 to 18 can optionally include, wherein the instructions further comprise instructions that when executed cause the one or more processors to store one or more of the user credentials and the latency period responsive to determining that the user credentials are successful to log-in into the web account.

In Example 20, the subject matter of Example 17 to 19 can optionally include, wherein the instructions further comprise instructions that when executed cause the one or more processors to discard one or more of the user credentials and the latency period responsive to determining that the user credentials are not successful to log-in into the web account.

In Example 21 the subject matter of Example 17 to 2 can optionally include, wherein the instructions to determine whether the user credentials are successful to log-in into the web account further comprise instructions that when executed cause the one or more processors to determine whether the refreshed web page includes one or more attributes indicative of a successful log-in into the web account.

Example 22 is a method for storing user credentials, comprising: transmitting a request for a web page; receiving a second web page responsive to transmitting the request, wherein the second web page includes information related to a web account of a user; transmitting user credentials within the second web page; capturing user credentials as they are being transmitted; analyzing a refreshed web page responsive to transmitting the user credentials; and determining whether the user credentials are successful to log-in into the web account.

In Example 23, the subject matter of Example 22 can optionally include monitoring latency period responsive to transmitting the user credentials.

In Example 24, the subject matter of Example 23 can optionally include storing one or more of the user credentials and the latency period responsive to determining that the user credentials are successful to log-in into the web account.

In Example 25, the subject matter of Example 22 to 24 can optionally include determining whether the refreshed web page includes one or more attributes indicative of a successful log-in into the web account.

Example 26 is a method for determining successful access to a web site, comprising: capturing user credentials for a web account as they are being entered; transmitting the user credentials for the web account to a web server, wherein the web account is associated with a web site; determining whether a refreshed web page is received from the web server responsive to transmitting the user credentials; determining whether the refreshed web page includes one or more attributes indicative of a successful log-in into the web site responsive to receiving the refreshed web page; and displaying information related to a second web page responsive to determining whether the refreshed web page includes the one or more attributes.

In Example 27, the subject matter of Example 26 can optionally include, wherein the instructions further comprise instructions that when executed cause the machine to transmit log-in information to a dashboard responsive to determining whether the refreshed web page includes the one or more attributes.

In Example 28, the subject matter of Example 27 can optionally include waiting for a predetermined latency period responsive to determining that the refreshed web page is not received from the web server.

In Example 29, the subject matter of Example 26 to 28 can optionally include reprocessing the web page responsive to waiting the predetermined latency period.

In Example 30, the subject matter of Example 26 to 29 can optionally include automatically retrieving and transmitting a user identification and a user password from memory to the web server.

In Example 31, the subject matter of Example 26 to 30 can optionally include receiving information related to determining whether the refreshed web page include the one or more attributes from a remote third-party server.

In Example 32, the subject matter of Example 26 to 31 can optionally include displaying user content associated with the web account in a display responsive to determining that the refreshed web page includes the one or more attributes.

In Example 33, the subject matter of Example 26 to 32 can optionally include not displaying user content associated with the web account in a display responsive to determining that the refreshed web page does not include the one or more attributes.

What is claimed is:

1. A machine readable medium, on which are stored instructions, comprising instructions that when executed cause a machine to:
capture user credentials for a web account;
transmit the user credentials for the web account to a web server, wherein the web account is associated with a web site;
determine whether a refreshed web page is received from the web server responsive to transmitting the user credentials ;
determine whether the refreshed web page includes one or more attributes indicative of a successful log-in into the web site responsive to receiving the refreshed web page; and
display information related to a second web page responsive to determining whether the refreshed web page includes the one or more attributes.

2. The machine readable medium of claim 1, wherein the instructions further comprise instructions that when executed cause the machine to transmit log-in information to a dashboard responsive to determining whether the refreshed web page includes the one or more attributes.

3. The machine readable medium of claim 1, wherein the instructions further comprise instructions that when executed cause the machine to:
wait for a predetermined latency period responsive to determining that the refreshed web page is not received from the web server.

4. The machine readable medium of claim 3, wherein the instructions further comprise instructions that when executed cause the machine to reprocess the web page responsive to waiting the predetermined latency period.

5. The machine readable medium of claim 1, wherein the instructions to transmit user credentials further comprise instructions that when executed cause the machine to automatically retrieve and transmit a user identification and a user password from memory to the web server.

6. The machine readable-medium of claim 1, wherein the instructions further comprise instructions that when executed cause the machine to receive information related to determining whether the refreshed web page include the one or more attributes from a remote third-party server.

7. The machine readable medium of claim 1, wherein the instructions to determine whether the refreshed web page includes the one or more attributes further comprise instructions that when executed cause the machine to display user content associated with the web account in a display responsive to determining that the refreshed web page includes the one or more attributes.

8. The machine readable medium of claim 1, wherein the instructions to determine whether the refreshed web page includes the one or more attributes further comprise instructions that when executed cause the machine to not display user content associated with the web account in a display responsive to determining that the refreshed web page does not include the one or more attributes.

9. A computer system for determining successful access to a web site, comprising:
one or more processors; and
a memory coupled to the one or more processors, on which are stored instructions, comprising instructions that when executed cause one or more of the processors to:
transmit user credentials for a web account to a web server, wherein the web account is associated with the web site;
determine whether a refreshed web page is received from the web server responsive to transmitting the user credentials ;
determine whether the refreshed web page includes one or more attributes indicative of a successful log-in into the web site responsive to receiving the refreshed web page; and
display information related to a second web page responsive to determining whether the refreshed web page includes the one or more attributes.

10. The computer system of claim 9, wherein the instructions further comprise instructions that when executed cause the one or more processors to transmit information related to the successful log-in to a dashboard responsive to determining whether the refreshed web page includes the one or more attributes.

11. The computer system of claim 9, wherein the instructions further comprise instructions that when executed cause the one or more processors to
Wait for a predetermined latency period responsive to determining that the refreshed web page is not received from the web server.

12. The computer system of claim 11, wherein the instructions further comprise instructions that when executed cause the one or more processors to reprocess the web page responsive to waiting the predetermined latency period.

13. The computer system of claim 9, wherein the instructions further comprise instructions that when executed cause the one or more processors to automatically retrieve and transmit a user identification and a user password from memory to the web server.

14. The computer system of claim 9, wherein the instructions further comprise instructions that when executed cause the one or more processors to receive information related to determining whether the refreshed web page include the one or more attributes from a remote third-party server.

15. The computer system of claim 9, wherein the instructions further comprise instructions that when executed cause the one or more processors to display user content associated with the web account in a display responsive to determining that the refreshed web page includes the one or more attributes.

16. The computer system of claim 9, wherein the instructions further comprise instructions that when executed cause the one or more processors to not display user content associated with the web account in a display responsive to determining that the refreshed web page does not include the one or more attributes.

17. A computer system for storing user information, comprising:
one or more processors; and
a memory coupled to the one or more processors, on which are stored instructions, comprising instructions that when executed cause one or more of the processors to:
transmit a request for a web page;
receive a second web page responsive to transmitting the request, wherein the second web page includes information related to a web account of a user;
transmit user credentials within the second web page;
capture user credentials as they are being transmitted;
analyze a refreshed web page responsive to transmitting the user credentials; and
determine whether the user credentials are successful to log-in into the web account.

18. The computer system of claim 17, wherein the instructions further comprise instructions that when executed cause the one or more processors to monitor latency period responsive to transmitting the user credentials.

19. The computer system of claim 18, wherein the instructions further comprise instructions that when executed cause the one or more processors to store one or more of the user credentials and the latency period responsive to determining that the user credentials are successful to log-in into the web account.

20. The computer system of claim 18, wherein the instructions further comprise instructions that when executed cause the one or more processors to discard one or more of the user credentials and the latency period responsive to determining that the user credentials are not successful to log-in into the web account.

21. The computer system of claim 17, wherein the instructions to determine whether the user credentials are successful to log-in into the web account further comprise instructions that when executed cause the one or more processors to determine whether the refreshed web page includes one or more attributes indicative of a successful log-in into the web account.

22. A method for storing user credentials, comprising:
transmitting a request for a web page;
receiving a second web page responsive to transmitting the request, wherein the second web page includes information related to a web account of a user;
transmitting user credentials within the second web page;
capturing user credentials as they are being transmitted;
analyzing a refreshed web page responsive to transmitting the user credentials; and
determining whether the user credentials are successful to log-in into the web account.

23. The method of claim 22, further comprising monitoring a latency period responsive to transmitting the user credentials.

24. The method of claim 23, further comprising storing one or more of the user credentials and the latency period responsive to determining that the user credentials are successful to log-in into the web account.

25. The method of claim 23, further comprising discarding one or more of the user credentials and the latency period responsive to determining that the user credentials are not successful to log-in into the web account.

26. The method of claim 22, further comprising determining whether the refreshed web page includes one or more attributes indicative of a successful log-in into the web account.
